(19) United States
(12) Patent Application Publication
(10) Pub. No.: US 2007/0177872 A1
(43) Pub. Date: Aug. 2, 2007

(54) Digital overlay

(76) Inventors: Ketan Gadkari, San Jose, CA (US); Brian Kinnard, Pleasanton, CA (US); Tom Warner, Moraga, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/346,466

(22) Filed: Feb. 1, 2006

(51) Int. Cl. H04B 10/20

(52) U.S. Cl. 398/58

(57) ABSTRACT

A method and apparatus for performing a digital overlay in a passive optical network is disclosed. In one embodiment the method comprises sending one or more Internet Group Management Protocol (IGMP) messages to an optical network unit (ONU) in a passive optical network (PON) using a first physical interface, and sending one or more multicast data streams associated with the one or more IGMP messages using a second physical interface, where the first and second physical interfaces are different.

### FIELD OF THE INVENTION

The present invention relates to the field of passive optical networks (PONs); more particularly, the present invention relates to a PON that includes a digital (e.g., a video) overlay.

### BACKGROUND OF THE INVENTION

Passive optical networks (PONs) are an access network technology that provides a method of deploying optical access lines between a carrier's central office (CO) and a customer site. PONs use passive optical splitters to split the optical signal from the CO into separate fibers to each customer site. A PON in the downstream direction emulates a broadcast network, in that all data is available at every end-point. A standard PON uses a single wavelength for downstream data (usually 1490 nm) and a single wavelength (usually 1310 nm) for upstream data. Typically, optical line terminals (OLTs) and optical network units (ONUs) are located at the end points of the PON. The OLT is located at the CO side while the ONU is located at the customer site.

PONs are an efficient way of providing high bandwidth services to business and residential subscribers. Typical services include broadband data, voice, and video. Video services can be provided as broadcast video and on-demand video. Common video delivery methods over a PON include modulating a laser with the RF content at the CO and receiving the video at the customer site with a RF detector, or delivering the video as data using Internet Protocol (IP). Video delivered using internet protocol (IP) is commonly called IP Video.

IP Video can be delivered to each customer site as a uni-cast stream, i.e. a separate stream per customer, or because of the broadcast nature of a PON, it can be delivered using a technique called multi-casting, using a protocol called internet group management protocol (IGMP). IGMP allows customers set-top boxes to join or leave a particular IP Video stream using their remote control devices. The benefit for the PON system is that only a single IP Video stream is needed to be sent down the PON for each channel currently being viewed, thus saving PON bandwidth. The IGMP protocol terminates at the Video Server at the CO side and the set-top box at the customer site. IGMP protocol messages are received/sent from the set-top box and the video server. The IGMP protocol expects that the IP Video data and IGMP protocol messages are received/transmitted from the same physical interface at the CO routers.

With the introduction of new video standards such as HDTV and SHDTV and the use of delivering that video via IP Video, PON system manufacturers are attempting to introduce higher-speed PONs that use higher-speed lasers and detectors in the downstream direction. There are a number of problems associated with introducing higher-speed PONs. These include the fact that higher-speed PONs requires higher-speed detectors with lower sensitivity. This has the effect of lowering the optical budget which decreases the distance or split count over which the PON can operate. Also a high-speed PON requires more expensive lasers and detectors. Lastly, a high-speed PON requires more expensive processing chips

### SUMMARY OF THE INVENTION

A method and apparatus for performing a digital overlay in a passive optical network (PON) is disclosed. In one embodiment, the method comprises sending one or more Internet Group Management Protocol (IGMP) messages to an optical network unit (ONU) in a passive optical network (PON) using a first physical interface and sending one or more multicast data streams associated with the one or more IGMP messages using a second physical interface, where the first and second physical interfaces are different.

### BRIEF DESCRIPTION OF THE DRAWINGS

The present invention will be understood more fully from the detailed description low and from the accompanying drawings of various embodiments of the invention, owever, should not be taken to limit the invention to the specific embodiments, but are anation and understanding only.

FIG. 1 illustrates one embodiment of a passive-optical network (PON) with a verlay.

FIG. 2 illustrates a block diagram of one embodiment of a central office (CO).

FIG. 3 illustrates a block diagram of one embodiment of an optical network unit (ONU).

FIG. 4 illustrates a block diagram of one embodiment of an optical interface.

### DETAILED DESCRIPTION OF THE PRESENT INVENTION

A digital overlay for a passive optical network (PON) is described herein. In one embodiment, the digital overlay is a video overlay. The overlay is implemented using an additional downstream wavelength. In such an approach, the speed of the standard PON downstream laser need not be increased to accommodate the increase in bandwidth. In other words, the PON optics are able to operate at normal speed, but a third wavelength at higher speed is added as a wavelength division multiplexed (WDM) overlay to increase the bandwidth.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Overview

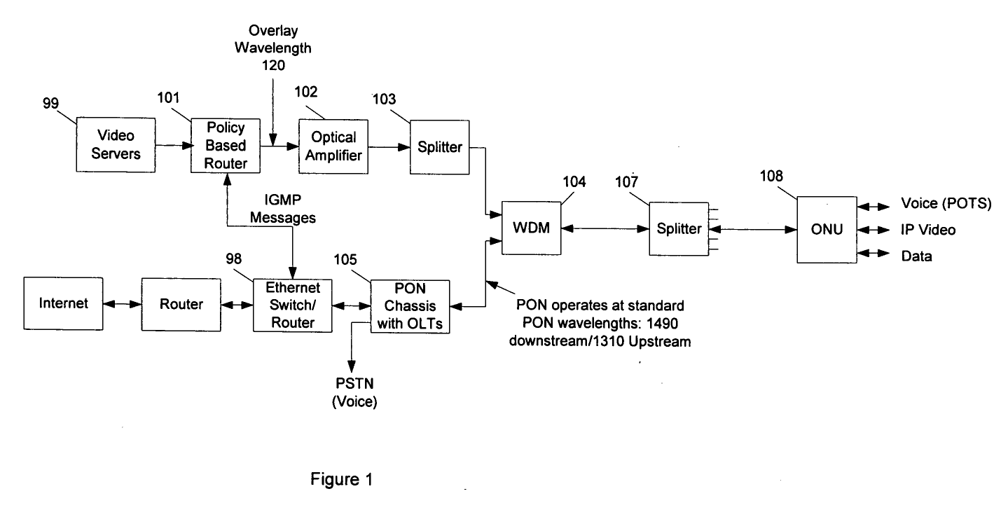

FIG. 1 is one embodiment of a passive-optical network with a digital overlay. Referring to FIG. 1, one or more video servers 99 are connected to policy based router 101. In one embodiment, video servers 99 and policy based router 101 exchange IGMP messages between each other. Video servers 99 also send video content in the form of IP Video to policy based router 101.

In one embodiment, policy based router 101 includes a high-speed laser interface to send information via overlay wavelength 120. More specifically, the IP Video data received from video server 99 is transferred as an optical signal using overlay wavelength 120. In one embodiment, overlay wavelength 120 is 1550 nm. Note that other wavelengths may be used, with the exception of those already in use in the network for data transfers on the same links over which the overlay information (e.g., the IP Video) is being transferred.

The optical signal from policy based router 101 is input to optical amplifier 102, where it is amplified. The amplified optical signal is sent to splitter 103. Splitter 103 divides the amplified optical signal into multiple signals that are sent to one or more wavelength division multiplexers (WDM), such as WDM 104.

WDM 104 is used to multiplex the optical signal from splitter 103 with optical signals from the PON link. In one embodiment, WDM 104 multiplexes the 1550 nm optical signal from splitter 103 with the standard PON wavelengths (e.g., 1490 nm (or any wavelength 1480-1500 nm) in the downstream direction and 1310 nm (or any wavelength 1260-1360) in the upstream direction). The signals received by WDM 104 from splitter 103 and PON chassis 105 are transmitted downstream to splitter 107, which operates in a manner well-known in the art. The optically divided signals from splitter 107 are sent to one or more ONUs, such as ONU 108. In response to the optical signal, ONU 108 generates separate IP Video and data streams. In one embodiment, ONU 108 also produces a Plain Old Telephone System (POTS) output.

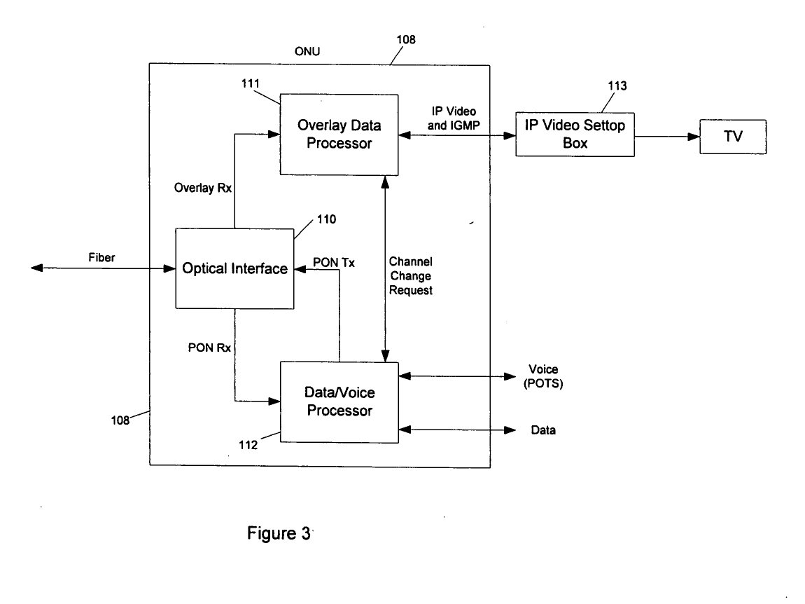

In one embodiment, ONU 108 comprises an optical interface, an overlay data processor, and a data/voice processor. FIG. 3 illustrates a block diagram of one embodiment of an ONU. Referring to FIG. 3, ONU 108 comprises an optical interface 110 that interfaces optical signals to and from an optical fiber. As part of the downstream operation, optical interface 110 receives the optical signal from an optical fiber and generates two data streams, one corresponding to the overlay and the other corresponding to the PON data based on the different wavelengths used to transfer the optical information on the optical fiber. The data corresponding to the received overlay information is forwarded to the overlay data processor 111. In one embodiment, overlay data processor 111 uses control information sent to it using IGMP from the data/voice processor 112 to select the correct IP video multi-cast stream(s) for the customer and sends them to the set-top box 113.

The data corresponding to the received PON data is input to data/voice processor 112. Data/voice processor 112 processes the data stream and delivers data and voice to the customer. In one embodiment, the PON data is output from ONU 108 on an Ethernet port. In one embodiment, data/voice processor 112 also generates a POTS output from ONU 108.

In the upstream direction, in one embodiment, overlay data processor 111 receives IGMP messages from the set-top box 113 to join or leave an 112 multicast stream (equivalent to a channel change request) and forwards it to data/voice processor 112. Overlay data processor 111 intercepts the requests and forwards it to data/voice processor 112. In response to this upstream traffic, data/voice processor 112 transmits these IGMP messages onto the fiber via optical interface 110 (through splitter 107 and WDM 104) to the OLT in PON chassis 105.

Referring back to FIG. 1, PON chassis 105 receives the optical signal being sent upstream via splitter 107 and WDM 104. In one embodiment, PON chassis 105 supports standard 1 Gbps PON links in a manner well-known in the art.

In one embodiment, PON chassis 105 is coupled to video servers 99 through Ethernet switch/router 98 and policy based router 101 and supports the processing and forwarding of IGMP messages to/from video servers 99 via policy based router 101 and Ethernet switch/router 98. In one embodiment, PON chassis 105 transfers a channel change request received from ONUs, such as ONU 108, to video servers 99 through Ethernet switch/router 98 and policy based router 101. Thus, the IGMP messages are forwarded to the appropriate video server via Ethernet switch/router 98 and the policy based router 101.

In one embodiment, the interface between PON chassis 105, Ethernet switch/router 98 and policy based router 101 are 1 Gbps Ethernet connections. Note that other types of links and/or connections may be used. Note also that a direct connection between PON chassis 105 and video servers 99 may be used instead of an Ethernet switch/router. Also, other types of switches and/or routers may be used.

In response to the request, the video server verifies the validity of the subscriber and adds the video requested to the multicast video stream. Note that the video stream may already contain the video requested in which case the video server does nothing.

In summary, video servers 99 provide IGMP messages and multicast data streams to policy based router 101. Policy based router 101 provides multi-cast data streams using a high-speed overlay to ONU 108 while sending IGMP protocol messages to OLT 105 via Ethernet switch/router 98, which forwards them to ONU 108 via the 1 G PON links. In one embodiment, the high speed overlay is 10 G Ethernet. In this manner, policy based router 101 uses one physical interface to transmit the multi-cast data streams and a different physical interface to transmit and receive the IGMP messages. This non-standard use of IGMP allows IGMP messages to flow on the standard PON links while the IP video data associated with those IGMP messages flows on the high-speed overlay.

Note that Ethernet switch/router 98 may be coupled to the Internet via another router.

An Example of a Central Office

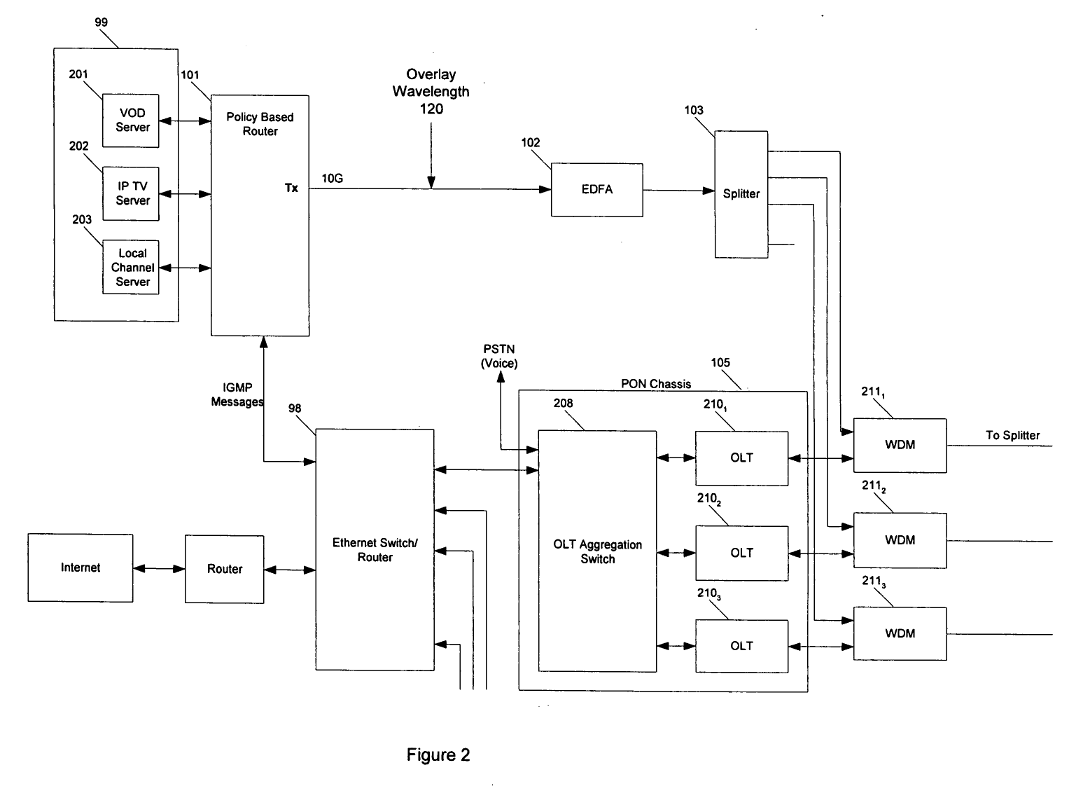

FIG. 2 is a block diagram of one embodiment of a central office (CO). Referring to FIG. 2, a Video-on-Demand (VOD) server 201, IPTV server 202 and local channel server 203 are communicably coupled to policy based router 101 to transmit and receive information with each other. Note that the CO is not required to have a VOD server 201, IPTV server 202 and a local channel interface, and may have only one or two of the three in alternative embodiments.

Policy based router 101 transmits information received from one or more of VOD server 201, IPTV server 202 and local channel server 203 optically to amplifier 102. In one embodiment, amplifier 102 is an EDFA and the stream is transmitted from policy based router 101 at 10 Gbps. The amplified optical signal from amplifier 102 is transmitted to splitter 103 which performs a well known splitting operation. Each optical signal separated from splitter 103 is sent to a wavelength division multiplexer, such as WDM 211₁₋₃, which transmits optical signals to another splitter. Each of WDM₁₋₃is connected via fiber to one of OLTs 210₁₋₃ to communicate information there between. OLTs 210₁₋₃ are each connected to communicate with OLT aggregation switch 208, which aggregates the traffic from multiple OLTs and connects to one port of Ethernet switch/router 98.

OLT aggregation switch 208 is also connected with other aggregation switches to Ethernet switch/router 98, which aggregates traffic from multiple OLT aggregation switches. Ethernet switch/router 98 is also coupled to policy based router 101. In one embodiment, Ethernet switch/router 98 is coupled to policy based router 101 via a 1 Gbps link that carries IGMP messages.

In the upstream direction, an OLT, such as OLT 210₁, receives the optical signal via splitter 107 and a WDM, such as WDM 211₁. IGMP messages are forwarded to the appropriate video server via the OLT aggregation switch 208, Ethernet switch/router 98 and the policy based router 101.

An Example of an Optical Interface

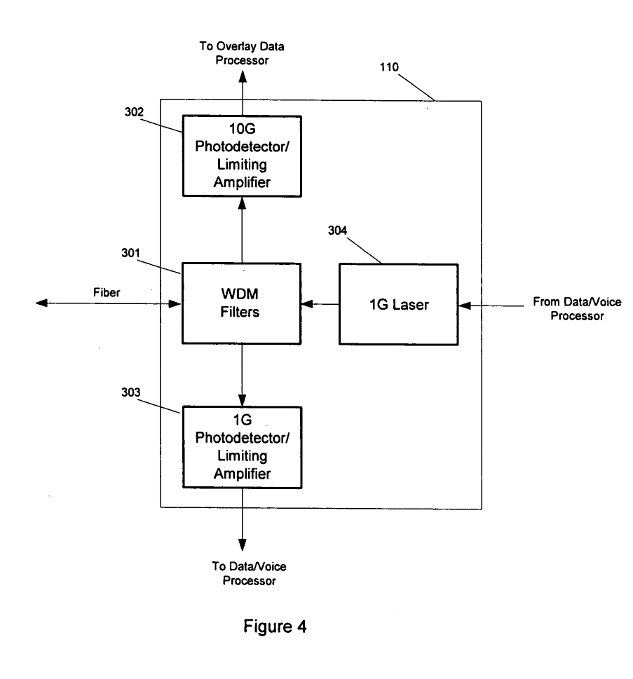

FIG. 4 illustrates a block diagram of one embodiment of an optical interface. In one embodiment, the optical interface is optical interface 110 of FIG. 3. Referring to FIG. 4, optical interface 110 comprises WDM filters 301, 10 Gbps photodetector & limiting amplifier 302, 1 Gbps photodetector & limiting amplifie 303, and 1 Gbps laser 304. The 10 Gbps photodetector 302 detects the digital (e.g., video overlay), while 1 Gbps photodetector 303 detects the standard 1 Gbps PON traffic. In one embodiment, the optical interface comprises a triplexer.

The output of 10 Gbps photodetector 302 is input to the overlay data processor 111 of the ONU, while the output of 1 Gbps photodetector 303 is input to the data/voice processor 112 of the ONU.

Optical interface 110 also includes 1 Gbps laser 304. The 1 Gbps laser 304 receives information from the data/voice processor 112 of the ONU and sends upstream data, voice, and IGMP messages as an optical signal towards the CO via WDM filters 301.

Note that in alternative embodiments, photodetectors and lasers other than 10 Gbps photodetector, 1 Gbps photodetector, and 1 Gbps laser may be used.

There are several advantages to the approach described above. First, the output of the overlay, on overlay wavelength 120, operating at high speed can be amplified and shared between multiple OLTs, thereby eliminating the need for an expensive downstream laser at each OLT. Also, the amplifier (e.g., an EDFA) can be selected to match the loss budget of the lower speed PON. This allows the system to maximize the split count and distance. Also, the cost of high-speed processing chips at the OLT is reduced, and possibly eliminated.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
sending one or more Internet Group Management Protocol (IGMP) messages to an optical network unit (ONU) in a passive optical network (PON) using a first physical interface; and
sending one or more multicast data streams associated with the one or more 1GMP messages using a second physical interface, the first and second physical interfaces being different.

2. The method defined in claim 1 wherein the one or more multicast data streams comprise IP video.

3. The method defined in claim 1 further comprising sending the one or more IGMP messages on a PON link while the one or more multicast data streams associated with the one or more IGMP messages flow on an overlay.

4. The method defined in claim 3 wherein the one or more multicast data streams comprise IP video.

5. The method defined in claim 3 wherein speed of the overlay is greater than speed of the PON link.

6. The method defined in claim 5 wherein the speed of the overlay is a magnitude greater than the speed of the PON link.

7. The method defined in claim 3 further comprising sending one or more IGMP messages upstream from the ONU on the PON link.

8. The method defined in claim 7 wherein the one or more IGMP messages sent upstream comprise a request that is satisfied with a multicast data stream sent using the second physical interface.
